(19) United States
(12) Patent Application Publication
(10) Pub. No.: US 2011/0254781 A1
(43) Pub. Date: Oct. 20, 2011

(54) STYLUS AND PORTABLE ELECTRONIC DEVICE UTILIZING SAME

(75) Inventors: SHI-XU LIANG, Shenzhen (CN); CHUNG-YEH SA, Santa Clara, CA (US)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/905,203

(22) Filed: Oct. 15, 2010

(30) Foreign Application Priority Data
Apr. 20, 2010 (CN) 201010151365.6

(51) Int. Cl. G06F 3/041; G06F 3/033

(52) U.S. Cl. 345/173; 345/179

(57) ABSTRACT

An exemplary stylus for portable electronic device with an electrostatic capacitive touch panel includes a main body, a touch nib, and a connecting element. The touch nib is electrically connected to the main body. The touch nib includes a flat or planar contacting portion to slide along the electrostatic capacitive touch panel with less pressure than traditional pointed styluses. The connecting element is pivotably connected the touch nib to the main body.

### BACKGROUND

1. Technical Field

This exemplary disclosure generally relates to a stylus for a portable electronic device.

2. Description of related art

It is well-known that a variety of electronic devices include a touch panel. Examples of such electronic devices include smart phones, personal digital assistants (PDA), pagers, personal organizers, and the like. These devices typically include a display module under the touch panel. The display module generates target images associated with menu options, programs, user choices, and other operations. The user controls the device by pressing the touch panel over the target image with a stylus. However, typical styluses have complex structures and cannot be used on electrostatic capacitance type touch panels.

Therefore, there is room for improvement within the art.

### BRIEF DESCRIPTION OF THE DRAWINGS

Many aspects of the exemplary stylus for a portable electronic device can be better understood with reference to the following drawings. The components in the drawings are not necessarily drawn to scale, the emphasis instead being placed upon clearly illustrating the principles of the stylus. Moreover, in the drawings, like reference numerals designate corresponding parts throughout the several views, in which:

FIG. 1 is an isometric view of a first embodiment of a stylus for a portable electronic device;

FIG. 2 is an exploded, isometric view of the stylus;

FIG. 3 is an isometric view showing the stylus used in a touch panel; and

FIG. 4 is an isometric view of a second embodiment of a stylus for a portable electronic device

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

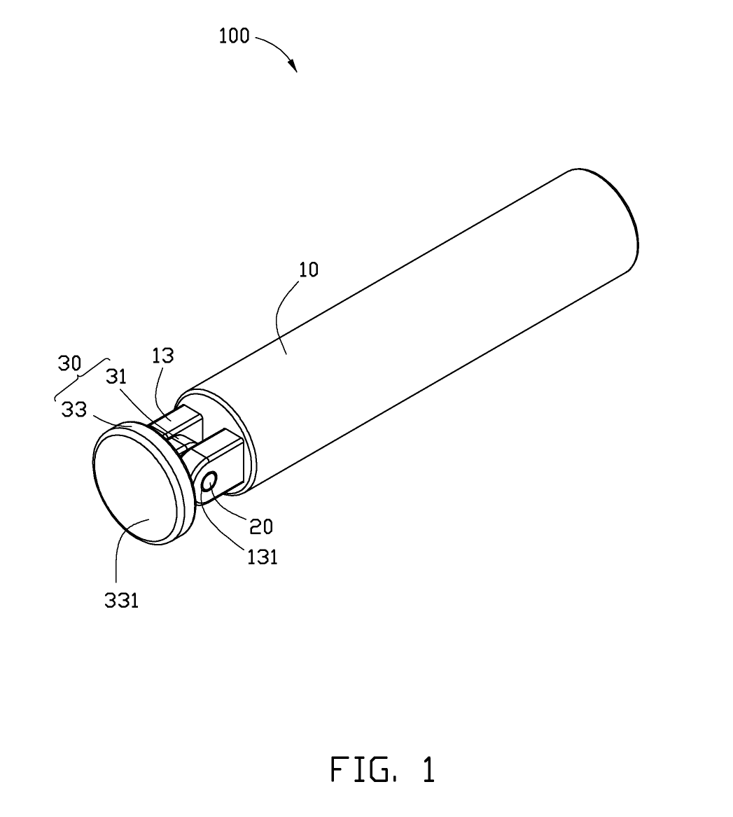

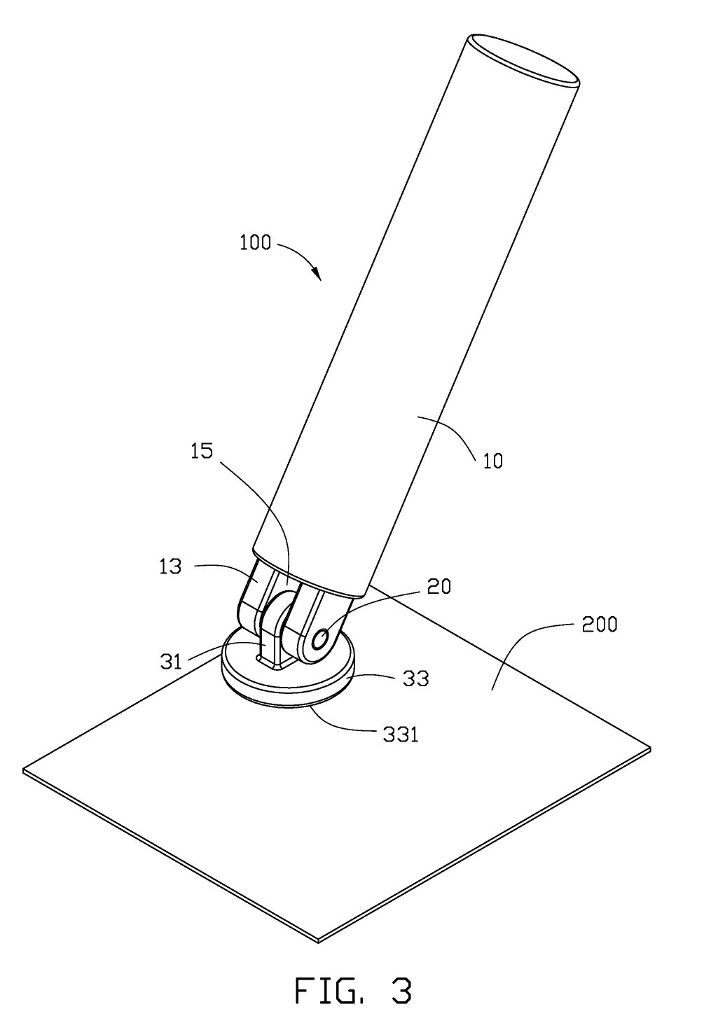

FIG. 1 is an exemplary embodiment of a stylus 100 for portable electronic devices, such as cellular phones or other electronic devices carrying an electrostatic capacitive touch panel 200 (as shown in FIG. 3). The stylus 100 includes a main body 10, a connecting element 20, and a touch nib 30. The touch nib 30 is pivotably connected to the main body 10 by the connecting element 20, so that the touch nib 30 can be adjusted by the user.

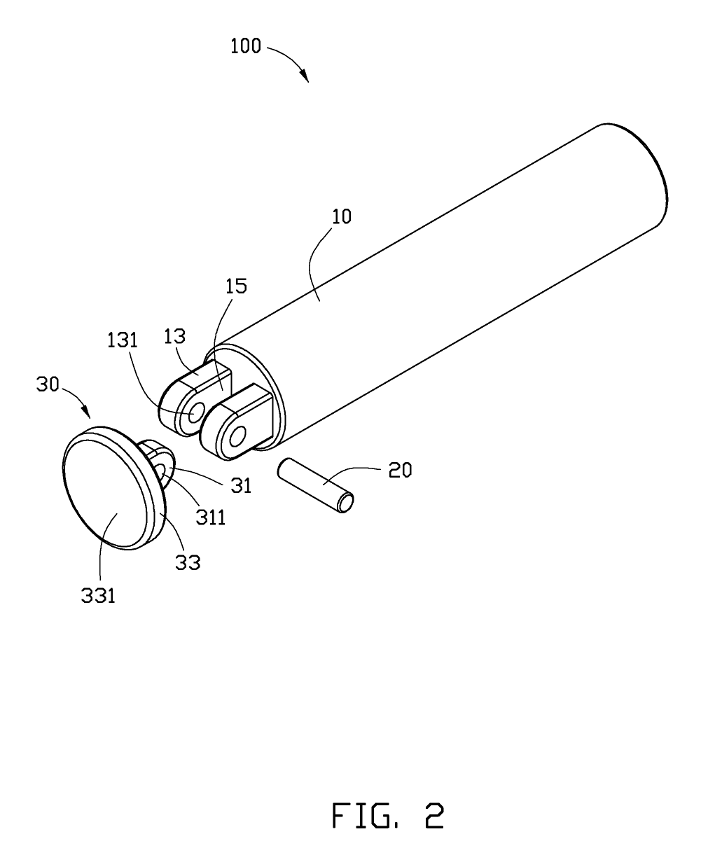

Referring to FIG. 2, two opposite blocks 13 substantially perpendicularly project from one end surface of the main body 10. The blocks 13 are integrally formed with main body 10 by, e.g., injection molding or punching. A receiving hole 131 is defined in each block 13. The two receiving holes 131 are aligned with each other, and are configured for receiving opposite ends of the connecting element 20. A receiving space 15 is defined between the two blocks 13. In the exemplary embodiment, the main body 10 is made of conductive materials, e.g. metal or conductive plastics.

The connecting element 20 is for pivotably connecting the touch nib 30 to the blocks 13 of the main body 10. A diameter of the connecting element 20 is substantially equal to the receiving holes 131. In the exemplary embodiment, the connecting element 20 is a cylindrical shaft and is made of conductive materials, e.g. metal or conductive plastics.

The touch nib 30 includes a contacting portion 33 and a knuckle portion 31 perpendicularly projecting from one surface of the contacting portion 33. The other surface of the contacting portion 33 is a flat or planar contacting surface 331. When the nib 30 is pressed to slide along the touch panel 200, the contacting surface 331 touches the touch panel 200. Because the contacting surface 331 is flat, unlike pointed-tip styluses, there is no sharp or pointed tip to press the touch panel 200 with a highly concentrated tip force or pressure. In other words, the current flat contacting surface 331 applies less pressure to the touch panel 200 than traditional pointed styluses. A through hole 311 is defined in the knuckle portion 31. The through hole 311 allows the connecting element 20 to extend through. In the exemplary embodiment, the touch nib 30 is made of conductive materials, e.g. metal or conductive plastics.

During assembly, the through hole 311 is aligned with the receiving holes 131 of the main body 10. The connecting element 20 is inserted into the through hole 311 and receiving hole 131 to connect the touch nib 30 to the main body 10. The distal end of the block 13 resists the touch nib 30. Thus, the stylus 100 is assembled. In the exemplary embodiment, the connecting element 20 may be further fixed to the blocks 13 by means of soldering or laser welding for example.

Referring to FIG. 3, when the stylus 100 is pressed to slide along the touch panel 200 to input information to the portable electronic device, the contacting surface 331 of the contacting portion 33 slides on the touch panel 200. When the disk 33 slides on the touch panel 200, the main body 10 can be adjusted by the user relative to the contacting portion 33 to a preferred position, for example 60 degrees.

Since the main body 10, the connecting element 20, and the touch nib 30 are all made of conductive materials, when the touch nib 30 slides on the touch panel 200, the touch panel 200 generates current changes for the portable electronic device. The touch panel 200 is not directly touched by the user's finger so that the temperature of the panel 200 will not be affected by the user thus preventing false input.

It is to be understood that the connecting element 20 can be replaced by a hinge. Furthermore, the main body 10, the connecting element 20, and the touch nib 30 can be made of dielectric materials and a layer of conductive materials coated thereon by plating.

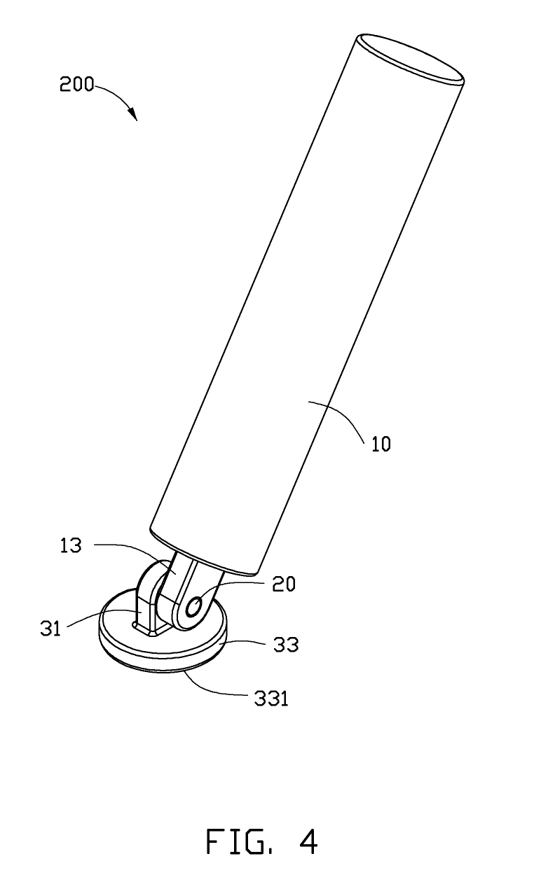

Referring to FIG. 4, in a second embodiment, a stylus 200 includes a main body 10, a connecting element 20, and a touch nib 30. A block 13 substantially perpendicularly project from one end surface of the main body 10. The touching nib 30 is pivotably connected to the main body 10 by the block 13.

The exemplary embodiment to the stylus 100 includes just a few components and the angle between the contacting surface 331 and the main body 10 can be adjusted, thus, the stylus 100 is easy to manufacture and use.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A stylus for a portable electronic device comprising:
a main body, the main body including a block projecting from one end thereof;
a touch nib comprising a planar contacting portion for contacting a touch panel of the portable electronic device and a knuckle portion extending from the contacting portion; and
a connecting element pivotably connecting the knuckle portion of the touch nib to the block of the main body.

2. The stylus as claimed in claim 1, wherein the main body, the touch nib, and the connecting element are made of conductive materials.

3. The stylus as claimed in claim 1, wherein each block defines a receiving hole, the knuckle portion defines a through hole, the connecting element extends through the through hole, and opposite ends of the connecting element are received in the holes.

4. The stylus as claimed in claim 1, wherein the main body can slant at an angle of about 60 degrees relative to the contacting portion.

5. The stylus as claimed in claim 1, wherein the connecting element is a cylindrical shaft.

6. A stylus for operating a touch panel comprising:
a main body;
a touch nib including a flat contacting surface for contacting the touch panel and generating electrostatic capacitive changes for a portable electronic device; and
a connecting element pivotably and electronically connecting the touch nib to the main body.

7. The stylus as claimed in claim 6, wherein the main body, the touch nib, and the connecting element are made of conductive materials.

8. The stylus as claimed in claim 7, wherein two spaced apart blocks project from one end of the main body, a knuckle portion projects from the contacting portion, the connecting element connects the knuckle portion to the blocks.

9. The stylus as claimed in claim 6, wherein the main body can slant at an angle of about 60 degrees relative to the contacting portion.

10. The stylus as claimed in claim 6, wherein the connecting element is a cylindrical shaft.

11. A portable electronic device comprising:
a touch panel; and
a stylus comprising:
a main body;
a touch nib including a flat contacting surface for contacting the touch panel and generating electrostatic capacitive changes for the portable electronic device; and
a connecting element pivotably and electronically connecting the touch nib to the main body.

12. The portable electronic device as claimed in claim 11, wherein the main body, the touch nib, and the connecting element are of conductive materials.

13. The portable electronic device as claimed in claim 12, wherein two opposite blocks project from one end of the main body, a knuckle portion projects from the contacting portion, the connecting element connects the knuckle portion to the blocks.

14. The portable electronic device as claimed in claim 11, wherein the main body can slant at an angle of about 60 degrees relative to flat contacting surface.

15. The portable electronic device as claimed in claim 13, wherein the connecting element is a cylindrical shaft made of conductive plastics or metal.
